(19) United States
(12) Patent Application Publication
(10) Pub. No.: US 2025/0117867 A1
(43) Pub. Date: Apr. 10, 2025

(54) INFORMATION PROCESSING DEVICE, SYSTEM, AND INFORMATION PROCESSING METHOD

(71) Applicant: Leave a Nest Co., Ltd., Tokyo (JP)

(72) Inventors: Kazuhiro HASEGAWA, Tokyo (JP); Hiroyuki TAKAHASHI, Tokyo (JP)

(73) Assignee: Leave a Nest Co., Ltd., Tokyo (JP)

(21) Appl. No.: 18/868,334

(22) PCT Filed: Nov. 16, 2023
(86) PCT No.: PCT/JP2023/041182

§ 371 Date: Nov. 22, 2024

(30) Foreign Application Priority Data
Nov. 17, 2022 (JP) 2022-183798

(51) Int. Cl. G06Q 50/18; G06Q 10/02

(52) U.S. Cl. CPC G06Q 50/18; G06Q 10/02

(57) ABSTRACT

An information processing device includes a control unit and a storage unit, and by the control unit executing a program stored in the storage unit, the information processing device accepts registration information regarding participants of an event, concludes a non-disclosure agreement between participants whose registration information has been accepted, and outputs information regarding whether or not each participant can participate in the event based on a status of conclusion of the non-disclosure agreement concluded between the participants of the event.

### TECHNICAL FIELD

The present disclosure relates to an information processing device, a system, and an information processing method.

### BACKGROUND ART

Hitherto, various systems for concluding non-disclosure agreements on a one-to-one basis via communication networks have been known (see, for example, Patent Literatures 1 to 3).

### CITATION LIST

### Patent Literature

Patent Literature 1: Japanese Laid-Open Patent Publication No. 2001-344394
Patent Literature 2: Japanese Laid-Open Patent Publication No. 2003-044701
Patent Literature 3: Japanese Laid-Open Patent Publication No. 2002-123763

### SUMMARY OF THE INVENTION

At events such as academic conferences and online meetings, there is a desire to maintain a state of secrecy for the contents of presentations made by presenters and conversations among participants by concluding non-disclosure agreements between the participants of the events. Specifically, there are cases where it is desired to restrict specific participants from participating in an event based on whether or not a non-disclosure agreement is concluded between the participants of the event. However, hitherto, there has been no system capable of performing such a process.

The present disclosure has been made in view of such circumstances, and an object of the present disclosure is to provide a program, an information processing device, a system, and an information processing method that enable participants to safely present and talk about things that the participants do not want to leak outside of an event.

An information processing device of the present disclosure is an information processing device including a control unit and a storage unit, wherein
by the control unit executing a program stored in the storage unit, the information processing device
accepts registration information regarding participants of an event,
concludes a non-disclosure agreement between the participants whose registration information has been accepted, and
outputs information regarding whether or not each participant can participate in the event based on a status of conclusion of the non-disclosure agreement concluded between the participants of the event.

In the information processing device of the present disclosure,
the information regarding whether or not each participant can participate in the event may include at least any of whether or not each participant can enter a predetermined real event venue, whether or not each participant can enter an event venue in a predetermined virtual space, and whether or not each participant can participate in a predetermined online conference.

In the information processing device of the present disclosure,
in concluding a non-disclosure agreement between the participants of the event, the information processing device may transmit confirmation information for confirming whether or not to conclude a non-disclosure agreement with another participant to a terminal of each participant whose registration information has been accepted, and may conclude a non-disclosure agreement between the participants of the event based on agreement information, accepted from the terminal of each participant, as to whether or not to conclude a non-disclosure agreement with another participant.

In this case, the confirmation information may be information for confirming for each of other participants whether or not to conclude a non-disclosure agreement with another participant, and the agreement information may be information of each of other participants as to whether or not to conclude a non-disclosure agreement.

In the information processing device of the present disclosure,
when concluding a non-disclosure agreement between the participants of the event, if the information processing device accepts the registration information regarding the participants of the event, the information processing device may transmit confirmation information for confirming whether or not to conclude a non-disclosure agreement with another participant who has already registered for participation in the event, to a terminal of a participant whose registration information has been accepted, and may conclude a non-disclosure agreement between the participants of the event based on agreement information, accepted from the terminal, as to whether or not to conclude a non-disclosure agreement with another participant.

In this case, the confirmation information may be information for confirming for each of other participants whether or not to conclude a non-disclosure agreement with another participant who has already registered for participation in the event, and the agreement information may be information of each of other participants as to whether or not to conclude a non-disclosure agreement.

In the information processing device of the present disclosure,
the information processing device may transmit the outputted information regarding whether or not each participant can participate in the event, to an event participation restriction device or an online conference management system configured to selectively restrict each participant from participating in the event.

Moreover, the information processing device may accept participation information regarding participation of a participant in the event, from an event participation confirmation device, and
when the information processing device accepts, from the event participation confirmation device, participation information regarding participation in the event of a participant whose registration information has been accepted, the information processing device may conclude a non-disclosure agreement between the participants of the event.

Moreover, the registration information regarding the participants of the event may include information that is at least either a presenter or an auditor, and
for a participant whose registration information is an auditor, the information processing device may output information that permits the participant to participate in the event even if a non-disclosure agreement has not been concluded with any other auditor but restricts the participant from participating in the event if a non-disclosure agreement has not been conducted with a presenter.

Moreover, the registration information regarding the participants of the event may further include information that is a conversation person, and
for a participant whose registration information is a conversation person, the information processing device may output information that restricts the participant from participating in the event if a non-disclosure agreement has not been concluded with any other participant.

Moreover, the status of conclusion of the non-disclosure agreement may include whether or not the non-disclosure agreement has been concluded and information on a content of the non-disclosure agreement, and the content of the non-disclosure agreement to be concluded may be determined based on an option selected from a plurality of agreement content options accepted from a terminal of the presenter.

Moreover, the registration information regarding the participants of the event may include information that is at least either a legal entity or an individual, and
when a participant is associated with a plurality of legal entities in the registration information, the information processing device may accept information as to which legal entity is to be held responsible when a secret is leaked.

Moreover, when there are participants who participate in the event at different times, the information processing device may output information regarding an indication for conclusion of the non-disclosure agreement between the participant who participates in the event later and the participant who has already participated in the event.

An information processing device of the present disclosure is an information processing device including a control unit and a storage unit,
by the control unit executing a program stored in the storage unit, the information processing device
accepts information regarding a status of conclusion of a non-disclosure agreement between participants, and
outputs information regarding whether or not each participant can participate in the event based on the accepted status of conclusion of the non-disclosure agreement between the participants of an event.

A system of the present disclosure is a system including an information processing device and an event participation restriction device, wherein
the information processing device includes a control unit and a storage unit,
by the control unit executing a program stored in the storage unit, the information processing device
   accepts registration information regarding participants of an event,
   concludes a non-disclosure agreement between the participants whose registration information has been accepted,
   outputs information regarding whether or not each participant can participate in the event based on a status of conclusion of the non-disclosure agreement concluded between the participants of the event, and
   transmits the outputted information regarding whether or not each participant can participate in the event, to the event participation restriction device, and
the event participation restriction device selectively restricts each participant from participating in the event based on the information, transmitted from the information processing device, regarding whether or not each participant can participate in the event.

An information processing method of the present disclosure is an information processing method performed by a computer, the information processing method including:
a step of causing the computer to accept registration information regarding participants of an event;
a step of causing the computer to conclude a non-disclosure agreement between the participants whose registration information has been accepted; and
a step of causing the computer to output information regarding whether or not each participant can participate in the event based on a status of conclusion of the non-disclosure agreement concluded between the participants of the event.

### BRIEF DESCRIPTION OF THE DRAWINGS

FIG. 1 is a schematic configuration diagram schematically showing the configuration of an information processing system according to an embodiment of the present invention.

FIG. 2 is a flowchart schematically showing the flow of information processing by a computer of the information processing system shown in FIG. 1.

FIG. 3 is a flowchart showing the details of a first mode of the flow of the information processing by the computer of the information processing system shown in FIG. 1.

FIG. 4 is a flowchart showing the details of a second mode of the flow of the information processing by the computer of the information processing system shown in FIG. 1.

FIG. 5 is a flowchart showing the details of a third mode of the flow of the information processing by the computer of the information processing system shown in FIG. 1.

### DESCRIPTION OF THE PREFERRED EMBODIMENTS

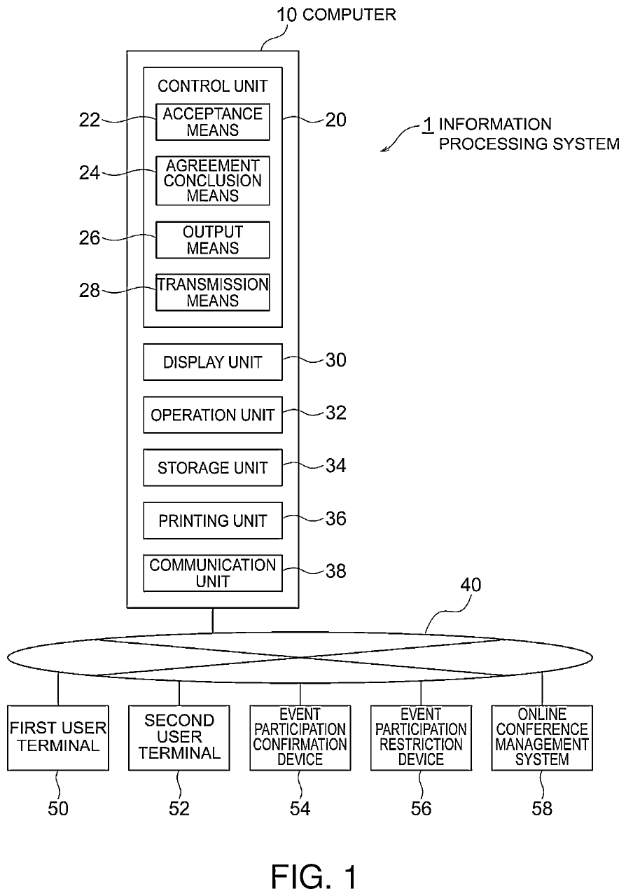

Hereinafter, an embodiment of the present invention will be described with reference to the drawings. FIG. 1 to FIG. 5 show an information processing system 1, an information processing method, etc., according to the present embodiment. A registration process for accepting registration information regarding participants of an event, a non-disclosure agreement conclusion process for concluding a non-disclosure agreement between the participants whose registration information has been accepted, and an event participation management process for outputting information regarding whether or not each participant can participate in the event are performed by the information processing system 1 according to the present embodiment. The event includes any of an event to be held at a predetermined real event venue, an event to be held at an event venue in a predetermined virtual space, a predetermined online conference, etc. When the event is held at a predetermined real event venue or an event venue in a predetermined virtual space, there may be cases where there is only one event venue, all participants enter this event venue, and a session in which auditors listen to a presentation by a presenter and conversation persons talk with each other is held, or there may be cases where there are multiple rooms in the event venue and a session is held in each room, where auditors listen to a presentation by a presenter and conversation persons talk with each other. The event includes an event that provides a place for people to talk with each other, and specific examples thereof include academic conferences, business discussions, exhibitions, etc.

The information processing system 1 according to the present embodiment includes a computer 10, a first user terminal 50, a second user terminal 52, an event participation confirmation device 54, an event participation restriction device 56, and an online conference management system 58. The computer 10 is communicatively connected to each of the first user terminal 50, the second user terminal 52, the event participation confirmation device 54, the event participation restriction device 56, and the online conference management system 58 via a communication network 40 such as an Internet line.

The computer 10 includes a control unit 20, a display unit 30, an operation unit 32, a storage unit 34, a printing unit 36, and a communication unit 38.

The control unit 20 is composed of a CPU (central processing unit) or the like, and controls the operation of the computer 10. Specifically, the control unit 20 functions as acceptance means 22, agreement conclusion means 24, output means 26, and transmission means 28 by executing a program stored in the storage unit 34 described later.

The acceptance means 22 accepts various kinds of information from an external device (e.g., the first user terminal 50, the second user terminal 52, the event participation confirmation device 54, etc.). Specifically, the acceptance means 22 accepts registration information regarding participants of an event from the first user terminal 50 and the second user terminal 52. The acceptance means 22 also accepts participation information regarding participation of the participants in the event from the event participation confirmation device 54. The agreement conclusion means 24 concludes a non-disclosure agreement between the participants whose registration information has been accepted by the acceptance means 22. The output means 26 outputs information regarding whether or not each participant can participate in the event, based on the status of conclusion of the non-disclosure agreement between the participants of the event concluded by the agreement conclusion means 24. The transmission means 28 transmits the information, outputted by the output means 26, regarding whether or not each participant can participate in the event, to an external device (e.g., the event participation restriction device 56, the online conference management system 58, etc.). The details of the functions of the acceptance means 22, the agreement conclusion means 24, the output means 26, and the transmission means 28 will be described later.

Here, the registration information regarding the participants of the event includes the name of the event, the name of each participant, information as to whether participation is being done in the name of the name of participation is a legal entity or an individual, the name of the belonging organization, gender, age, a telephone number, an e-mail address, a participation qualification, an identification number issued by the event organizer, etc. The participation qualification includes presenters, auditors, conversation persons, etc. A presenter is a person who makes a presentation in a session at the event venue. In the present embodiment, when a presenter makes a presentation in a session, the presenter is not obligated to maintain confidentiality, but can obligate the other persons (auditors) to maintain confidentiality. An auditor is a person who listens to the content of a presentation by a presenter in a session at the event venue. In the present embodiment, when a presenter makes a presentation in a session, the auditors are obligated to maintain confidentiality. Even if an auditor asks a question to the presenter within the session, the question is not protected by a non-disclosure agreement. A conversation person is a person who can talk with another participant nearby at the event venue. In the present embodiment, a conversation person is obligated to maintain confidentiality and can also obligate the other persons to maintain confidentiality.

The status of conclusion of the non-disclosure agreement includes whether or not the non-disclosure agreement has been concluded and information on the content of the non-disclosure agreement. The information on the content of the non-disclosure agreement includes information such as the level of the non-disclosure agreement, the period of validity of the non-disclosure agreement, etc. In the present embodiment, the level of the non-disclosure agreement can be changed for each session at the event venue, each presenter, or each participant. For example, if the level is 5, a provision that the content of a presentation in a session cannot be used for business by the auditors, is included in the non-disclosure agreement. If the level is 3, a provision that the content of the presentation in the session can be conditionally used for business by the auditors, is included in the non-disclosure agreement. If the level is 1, a provision that the content of the presentation in the session can be used for business by the auditors, is included in the non-disclosure agreement. Such a level of the non-disclosure agreement is determined, for example, by the presenter who makes the presentation in the session. Examples of the period of validity of the non-disclosure agreement include one month, three months, six months, etc., from the date of the event. As the information on the content of the non-disclosure agreement, the non-disclosure agreement may include a provision that a patent application shall not be filed for any matter regarding the content of the presentation in the session until a predetermined period of time has elapsed from the date of the event, and a provision that the presenter shall be notified if a patent application is to be filed for a matter regarding the content of the presentation at the session until a predetermined period of time has elapsed from the date of the event.

The information regarding whether or not each participant can participate in the event includes at least any of whether or not each participant can enter a predetermined real event venue, whether or not each participant can enter an event venue in a predetermined virtual space, and whether or not each participant can participate in a predetermined online conference.

The display unit 30 is, for example, a monitor or the like, and displays various screens by receiving display command signals from the control unit 20. The operation unit 32 is, for example, a keyboard or the like, and can give various commands to the control unit 20. In the present embodiment, a display/operation unit such as a touch panel in which the display unit 30 and the operation unit 32 are integrated may be used.

The storage unit 34 is composed of, for example, an HDD (Hard Disk Drive), a RAM (Random Access Memory), a ROM (Read Only Memory), and an SSD (Solid State Drive). The storage unit 34 is not limited to one included in the computer 10, but may be a storage medium (e.g., USB memory) that can be detachably attached to the computer 10. In the present embodiment, the storage unit 34 stores therein the program to be executed by the control unit 20, the registration information regarding the participants of the event accepted by the acceptance means 22, the status of conclusion of the non-disclosure agreement between the participants of the event concluded by the agreement conclusion means 24, etc.

The printing unit 36 includes, for example, a printer or the like, and prints the information regarding whether or not each participant can participate in the event (specifically, for example, a list of the participants in the event) outputted by the output means 26, on paper.

The communication unit 38 includes a communication interface for transmitting and receiving signals to and from an external device (e.g., the first user terminal 50, the second user terminal 52, the event participation confirmation device 54, the event participation restriction device 56, the online conference management system 58, etc.) wirelessly or via a wire.

The first user terminal 50 and the second user terminal 52 are each held by a participant who participates in the event. Examples of each of the first user terminal 50 and the second user terminal 52 include a personal computer, a smartphone, a tablet terminal, etc. In FIG. 1, the first user terminal 50 and the second user terminal 52 are merely shown, but there are actually multiple user terminals corresponding to the respective participants who participate in the event, and each user terminal is communicatively connected to the computer 10 via the communication network 40 such as an Internet line.

The event participation confirmation device 54 is installed, for example, at the entrance or the like of the predetermined real event venue or the event venue in the predetermined virtual space, and confirms the participants who are about to participate in the event at the event venue. In the case where there are multiple rooms in the event venue and a session is held in each room where auditors listen to a presentation by a presenter and conversation persons talk with each other, the event participation confirmation device 54 may be installed at the entrance of each room. Examples of the event participation confirmation device 54 include a camera, an IC tag reader, a barcode reader, a personal computer, etc. In the case where the event participation confirmation device 54 is a camera, the event participation confirmation device 54 captures a facial image of a participant who is about to participate in the event at the event venue, and confirms the participant based on the captured facial image of the participant. If a participant holds an admission ticket having a two-dimensional code printed thereon or a portable terminal capable of displaying a two-dimensional code on a monitor thereof, the event participation confirmation device 54 captures an image of the two-dimensional code displayed on the admission ticket or the portable terminal held by the participant who is about to participate in the event at the event venue, and confirms the participant based on the captured image of the two-dimensional code. In the case where the event participation confirmation device 54 is an IC tag reader, the event participation confirmation device 54 reads an IC tag held by a participant who is about to participate in the event at the event venue, and confirms the participant based on information (e.g., identification information of the participant) stored in the IC tag. In the case where the event participation confirmation device 54 is a personal computer, the event participation confirmation device 54 confirms a participant who is about to participate in the event, by an event receptionist at the event venue inputting the name or the like of the participant, which is obtained from the participant, into the event participation confirmation device 54. The event participation confirmation device 54 is communicatively connected to the computer 10 via the communication network 40 such as an Internet line. Accordingly, the participation information regarding participation of the participants in the event is transmitted from the event participation confirmation device 54 to the computer 10.

The event participation restriction device 56 is installed, for example, at the entrance or the like of the predetermined real event venue or the event venue in the predetermined virtual space, and selectively restricts the participants from participating in the event at the event venue. In the case where there are multiple rooms in the event venue and a session is held in each room where auditors listen to a presentation by a presenter and conversation persons talk with each other, the event participation restriction device 56 may be installed at the entrance of each room. Examples of the event participation restriction device 56 include a gate facility, a monitor, a personal computer, and the like. The event participation restriction device 56 is communicatively connected to the computer 10 via the communication network 40 such as an Internet line. Accordingly, the information regarding whether or not each participant can participate in the event is transmitted from the computer 10 to the event participation restriction device 56. In the case where the event participation restriction device 56 is a gate facility, a gate is closed for each participant restricted from participating in the event, based on the information transmitted from the computer 10 regarding whether or not each participant can participate in the event, whereby this participant cannot enter the event venue. In the case where the event participation restriction device 56 is a monitor, a personal computer, or the like, information on each participant restricted from participating in the event is displayed on the monitor, the personal computer, or the like based on the information transmitted from the computer 10 regarding whether or not each participant can participate in the event, whereby the event receptionist is allowed to restrict such a participant from participating in the event.

In the present embodiment, a device in which the event participation confirmation device 54 and the event participation restriction device 56 are combined may be used. Also, only one of the event participation confirmation device 54 and the event participation restriction device 56 may be used instead of using both the event participation confirmation device 54 and the event participation restriction device 56. As yet another example, both the event participation confirmation device 54 and the event participation restriction device 56 do not have to be used.

The online conference management system 58 manages an online conference in which each participant participates at their own terminal such as the first user terminal 50 or the second user terminal 52. Specifically, the online conference management system 58 transmits and receives signals to and from the terminals such as the first user terminal 50 and the second user terminal 52 via the communication network 40 such as an Internet line, thereby allowing the online conference to be held at the first user terminal 50 and the second user terminal 52. The online conference management system 58 is communicatively connected to the computer 10 via the communication network 40 such as an Internet line. Accordingly, the information regarding whether or not each participant can participate in the event is transmitted from the computer 10 to the online conference management system 58. Based on the information transmitted from the computer 10 regarding whether or not each participant can participate in the event, the online conference management system 58 transmits an instruction signal to each terminal 50 or 52 such that each participant restricted from participating in the event cannot participate in the online conference at their terminal such as the first user terminal 50 or the second user terminal 52.

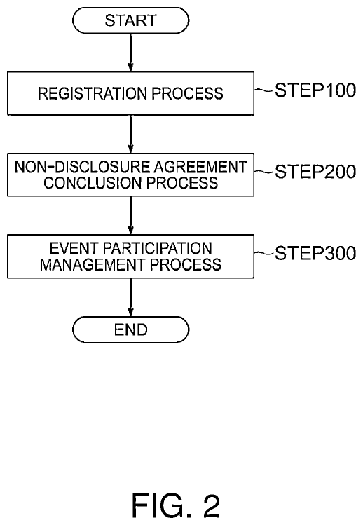

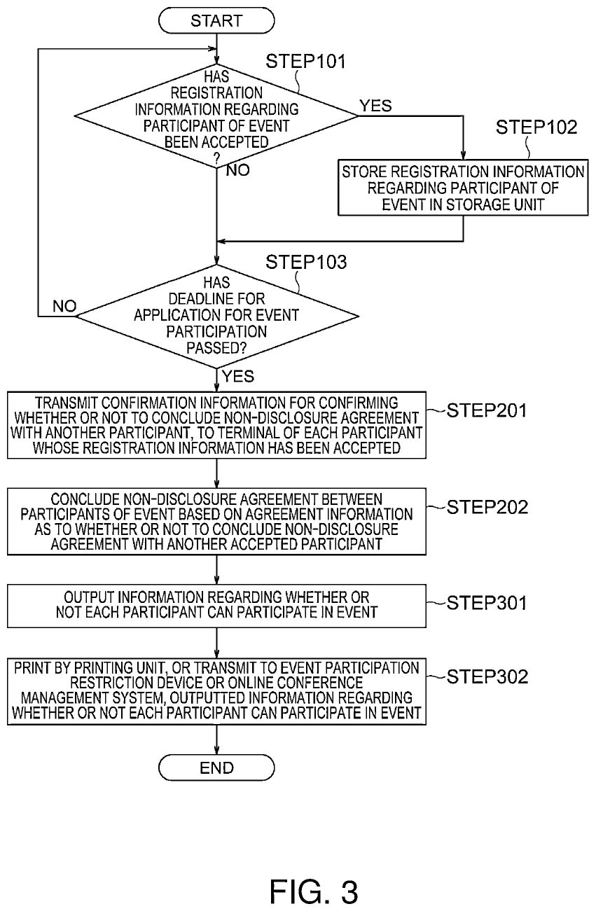

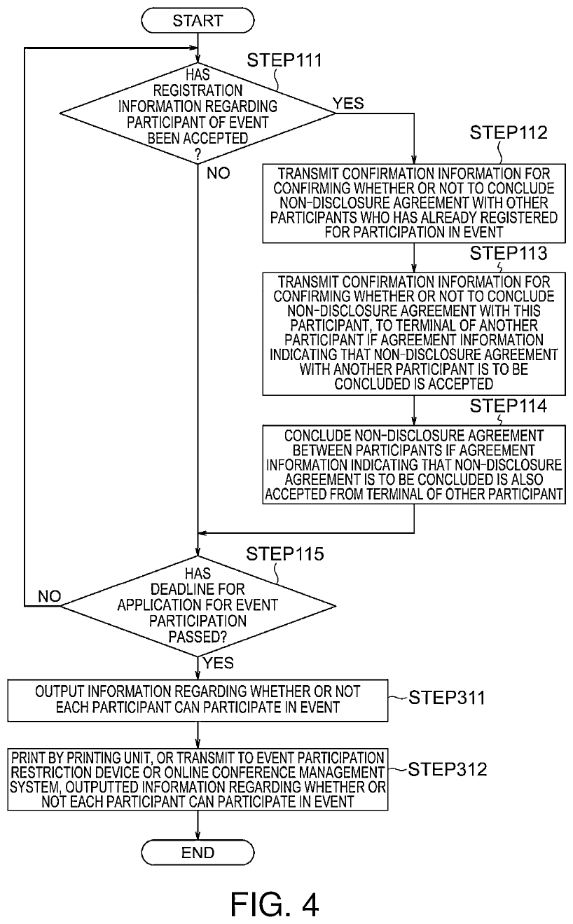

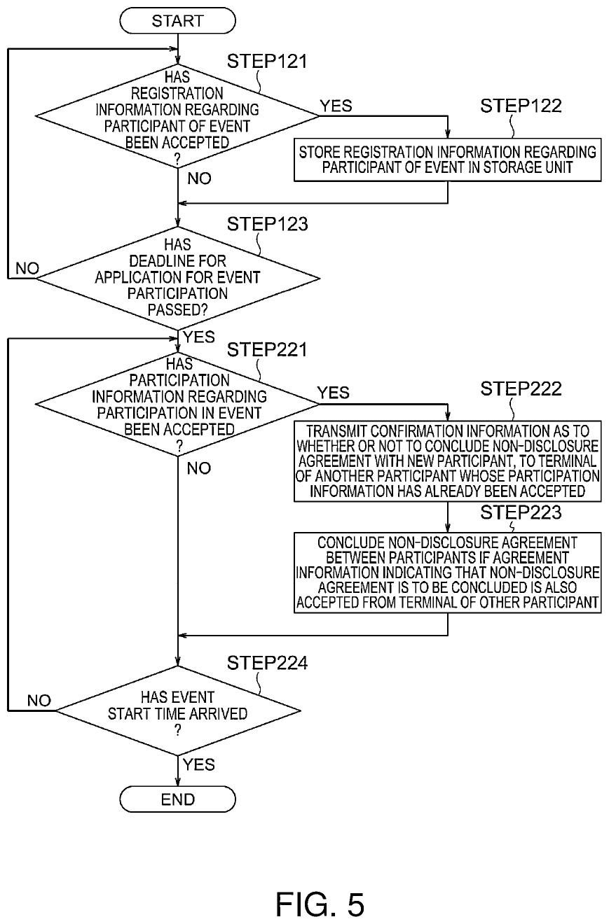

Next, an information processing method by such a computer 10 will be described with reference to FIG. 2 to FIG. 5. Here, FIG. 2 is a flowchart schematically showing the flow of information processing by the computer 10 of the information processing system 1 shown in FIG. 1, and FIG. 3 is a flowchart showing the details of a first mode of the flow of the information processing by the computer 10 of the information processing system 1 shown in FIG. 1. FIG. 4 is a flowchart showing the details of a second mode of the flow of the information processing by the computer 10 of the information processing system 1 shown in FIG. 1, and FIG. 5 is a flowchart showing the details of a third mode of the flow of the information processing by the computer 10 of the information processing system 1 shown in FIG. 1. The following processes described below are performed by the control unit 20 executing the program stored in the storage unit 34.

As shown in FIG. 2, in the computer 10 according to the present embodiment, by the control unit 20 executing the program stored in the storage unit 34, a registration process of accepting registration information regarding participants of an event (STEP 100 in FIG. 2), a non-disclosure agreement conclusion process of concluding a non-disclosure agreement between the participants whose registration information has been accepted (STEP 200 in FIG. 2), and an event participation management process of outputting information regarding whether or not each participant can participate in the event (STEP 300 in FIG. 2) are performed. The registration process, the non-disclosure agreement conclusion process, and the event participation management process may be performed separately. Alternatively, the registration process and the non-disclosure agreement conclusion process may be performed simultaneously. Still alternatively, the non-disclosure agreement conclusion process and the event participation management process may be performed simultaneously.

In the first mode of the flow of the information processing by the computer 10 of the present embodiment, the registration process, the non-disclosure agreement conclusion process, and the event participation management process are performed separately. The details of the flow of information processing according to such a first mode will be described with reference to the flowchart in FIG. 3.

First, the details of the registration process (STEP 100 in FIG. 2) will be described. When a participant who wishes to participate in an event inputs registration information by means of the first user terminal 50 or the second user terminal 52, the inputted registration information is transmitted from the first user terminal 50 or the second user terminal 52 to the computer 10 via the communication network 40 such as an Internet line. When the acceptance means 22 accepts registration information regarding a participant of an event (“YES” in STEP 101 in FIG. 3), the control unit 20 stores the registration information regarding the participant in the event, in the storage unit 34 (STEP 102 in FIG. 3). Until a deadline for application for event participation has passed (“NO” in STEP 103 in FIG. 3), each participant who wishes to participate in the event can register for participation in the event by means of the first user terminal 50 or the second user terminal 52.

Next, the details of the non-disclosure agreement process (STEP 200 in FIG. 2) will be described. After the deadline for application for event participation has passed (“YES” in STEP 103 in FIG. 3), confirmation information for confirming whether or not to conclude a non-disclosure agreement with another participant is transmitted by the transmission means 28 to the terminal 50 or 52 of each participant whose registration information has been accepted, and the confirmation information is displayed on each terminal 50 or 52 (STEP 201 in FIG. 3). Then, when the participant inputs information (agreement information) as to whether or not to conclude a non-disclosure agreement with another participant by means of their terminal 50 or 52, the inputted agreement information is transmitted from each terminal 50 or 52 to the computer 10, and the acceptance means 22 accepts the agreement information from each terminal 50 or 52 of the participants whose registration information has been accepted by the acceptance means 22. The agreement conclusion means 24 concludes a non-disclosure agreement between the participants of the event based on the agreement information accepted by the acceptance means 22 as to whether or not to conclude a non-disclosure agreement with another participant (STEP 202 in FIG. 3).

Here, the confirmation information is information for confirming for each of other participants whether or not to conclude a non-disclosure agreement with another participant. Therefore, on a confirmation screen displayed on the terminal 50 or 52 of each participant for whether or not to conclude a non-disclosure agreement, whether or not to conclude a non-disclosure agreement is confirmed for each of other participants. Specifically, on the confirmation screen displayed on the terminal 50 or 52 of each participant for whether or not to conclude a non-disclosure agreement, the name, etc., of each of other participants are displayed, a check box is also displayed for each of other participants, and by checking the check box for each of other participants, information indicating that a non-disclosure agreement with this participant is to be concluded can be inputted. On the confirmation screen displayed on the terminal 50 or 52 of each participant, all check boxes may be initially checked, and it may be possible to uncheck the check box corresponding to a specific other participant. In addition, on the confirmation screen for whether or not to conclude a non-disclosure agreement, a button for collectively checking all the check boxes may be displayed, and in this case, it may be possible to input information indicating that a non-disclosure agreement with all the other participants is to be concluded, when this button is pressed. Moreover, on the confirmation screen displayed on the terminal 50 or 52 of each participant for whether or not to conclude a non-disclosure agreement, instead of a check box being displayed for each of other participants, a check box corresponding to each of categories of presenter, auditor, and conversation person is displayed, and by checking the check box corresponding to each of these categories, information indicating whether or not a non-disclosure agreement with each of a presenter, an auditor, and a conversation person is to be concluded can be inputted.

The agreement information is information of each of other participants as to whether or not to conclude a non-disclosure agreement. That is, the agreement conclusion means 24 concludes a non-disclosure agreement between each participant for a plurality of participants whose registration information has been accepted by the acceptance means 22.

Next, the details of the event participation management process (STEP 300 in FIG. 2) will be described. Based on the status of conclusion of the non-disclosure agreement between the participants of the event concluded by the agreement conclusion means 24, the output means 26 outputs information regarding whether or not each participant can participate in the event (STEP 301 in FIG. 3). For example, for a participant whose registration information is a presenter, the output means 26 outputs information that permits the participant to participate in the event even if a non-disclosure agreement has not been concluded with any other participant. In addition, for a participant whose registration information is an auditor, the output means 26 outputs information that permits the participant to participate in the event even if a non-disclosure agreement has not been concluded with any other auditor by the agreement conclusion means 24. On the other hand, for a participant whose registration information is an auditor, the output means 26 outputs information that restricts the participant from participating in the event if a non-disclosure agreement has not been concluded with the presenter. In addition, for a participant whose registration information is a conversation person, the output means 26 outputs information that restricts the participant from participating in the event if a non-disclosure agreement has not been concluded with any other participant by the agreement conclusion means 24. As described above, for each participant whose registration information has been accepted by the acceptance means 22, the output means 26 outputs information as to whether or not to permit the participant from participating in the event.

The transmission means 28 transmits the information outputted by the output means 26 regarding whether or not each participant can participate in the event, to the event participation restriction device 56 or the online conference management system 58 (STEP 302 in FIG. 3). Specifically, when the event is held at a real event venue, the information outputted by the output means 26 regarding whether or not each participant can participate in the event is transmitted by the transmission means 28 to a gate facility serving as the event participation restriction device 56. Accordingly, the gate of the gate facility is closed for each participant restricted from participating in the event, based on the information transmitted by the transmission means 28 regarding whether or not each participant can participate in the event, whereby this participant cannot enter the event venue. Alternatively, the information outputted by the output means 26 regarding whether or not each participant can participate in the event may be transmitted by the transmission means 28 to a monitor, a personal computer, or the like serving as the event participation restriction device 56. The monitor, the personal computer, or the like is installed at the entrance of the event venue, and information on each participant restricted from participating in the event is displayed on the monitor, the personal computer, or the like, whereby an event receptionist can restrict such a participant from participating in the event.

Even when the event is held at an event venue in a virtual space, the information outputted by the output means 26 regarding whether or not each participant can participate in the event is transmitted by the transmission means 28 to a gate facility installed as the event participation restriction device 56 in the virtual space. Accordingly, the gate of the gate facility is closed in the virtual space for each participant restricted from participating in the event, based on the information transmitted by the transmission means 28 regarding whether or not each participant can participate in the event, whereby an avatar or the like of this participant cannot not enter the event venue.

When the event is held as an online conference, the information outputted by the output means 26 regarding whether or not each participant can participate in the event is transmitted by the transmission means 28 to the online conference management system 58. Accordingly, based on the information transmitted from the computer 10 regarding whether or not each participant can participate in the event, an instruction signal is transmitted from the online conference management system 58 to each terminal 50 or 52 such that each participant restricted from participating in the event cannot participate in the online conference at their terminal such as the first user terminal 50 or the second user terminal 52.

Instead of or in addition to the transmission means 28 transmitting, to the event participation restriction device 56 or the online conference management system 58, the information outputted by the output means 26 regarding whether or not each participant can participate in the event, the information outputted by the output means 26 regarding whether or not each participant can participate in the event may be printed on paper by the printing unit 36 (STEP 302 in FIG. 3). For example, based on the information outputted by the output means 26 regarding whether or not each participant can participate in the event, a list of participants permitted to participate in the event is printed on paper by the printing unit 36. In this case, the paper on which the information regarding whether or not each participant can participate in the event is printed is brought to the real event venue, whereby the event receptionist can permit or restrict participation of each participant in the event while viewing the information printed on the paper.

Next, the second mode of the flow of the information processing by the computer 10 of the present embodiment will be described. In the second mode, the registration process and the non-disclosure agreement conclusion process are performed in an integrated manner, and then the event participation management process is performed. The details of the flow of information processing according to such a second mode will be described with reference to the flowchart in FIG. 4.

First, the details of the registration process (STEP 100 in FIG. 2) will be described. When a participant who wishes to participate in an event inputs registration information by means of the first user terminal 50 or the second user terminal 52, the inputted registration information is transmitted from the first user terminal 50 or the second user terminal 52 to the computer 10 via the communication network 40 such as an Internet line. When the acceptance means 22 accepts registration information regarding a participant of an event (“YES” in STEP 111 in FIG. 3), the control unit 20 stores the registration information regarding the participant in the event, in the storage unit 34. In addition, the transmission means 28 transmits confirmation information as to whether or not to conclude a non-disclosure agreement with each of other participants who have already registered for participation in the event (STEP 112 in FIG. 3). Specifically, when the participant holding the first user terminal 50 has already registered for participation and the participant holding the second user terminal 52 is about to register for participation, if the participant holding the second user terminal 52 inputs registration information by means of the second user terminal 52, and the inputted registration information is transmitted from the second user terminal 52 to the computer 10 via the communication network 40 such as an Internet line, the transmission means 28 transmits, to the second user terminal 52, confirmation information as to whether or not to conclude a non-disclosure agreement with the participant who holds the first user terminal 50 and who has already registered for participation in the event.

The participant holding the second user terminal 52 inputs information as to whether or not to conclude a non-disclosure agreement with another participant, for each of other participants, by means of the second user terminal 52. Here, the confirmation information transmitted by the transmission means 28 to the second user terminal 52 is information for confirming for each of other participants whether or not to conclude a non-disclosure agreement with another participant. Therefore, on the confirmation screen displayed on the second user terminal 52 for whether or not to conclude a non-disclosure agreement, whether or not to conclude a non-disclosure agreement is confirmed for each of other participants. Then, if the participant holding the second user terminal 52 inputs information indicating that a non-disclosure agreement with another participant is to be concluded by means of the second user terminal 52, agreement information indicating that the participant holding the second user terminal 52 is willing to conclude a non-disclosure agreement with another participant is transmitted from the second user terminal 52 to the computer 10. Here, the agreement information transmitted as a reply from the second user terminal 52 to the computer 10 is information of each of other participants as to whether or not to conclude a non-disclosure agreement.

If the acceptance means 22 accepts, from the second user terminal 52, agreement information indicating that a non-disclosure agreement with another participant is to be concluded, the transmission means 28 transmits confirmation information for confirming whether or not to conclude a non-disclosure agreement with this participant, to the terminal of another participant (STEP 113 in FIG. 4). Specifically, if the acceptance means 22 accepts, from the second user terminal 52, agreement information indicating that a non-disclosure agreement with the participant holding the first user terminal 50 is to be concluded, the transmission means 28 transmits confirmation information for confirming whether or not to conclude a non-disclosure agreement with the participant holding the second user terminal 52, to the first user terminal 50. Then, the participant holding the first user terminal 50 inputs information as to whether or not to conclude a non-disclosure agreement with another participant (specifically, the participant holding the second user terminal 52) by means of the first user terminal 50. Then, if the participant holding the first user terminal 50 inputs information indicating that a non-disclosure agreement with the participant holding the second user terminal 52 is to be concluded by means of the first user terminal 50, agreement information indicating that the participant holding the first user terminal 50 is also willing to conclude a non-disclosure agreement with the participant holding the second user terminal 52 is transmitted from the first user terminal 50 to the computer 10.

Then, if the acceptance means 22 also accepts, from the first user terminal 50, the agreement information indicating that a non-disclosure agreement with the participant holding the second user terminal 52 is to be concluded, the agreement conclusion means 24 concludes a non-disclosure agreement between the participant holding the first user terminal 50 and the participant holding the second user terminal 52 (STEP 114 in FIG. 4).

Until an deadline for application for event participation has passed (“NO” in STEP 115 in FIG. 4), each participant who wishes to participate in the event can register for participation in the event by means of the first user terminal 50 or the second user terminal 52.

Next, the details of the event participation management process (STEP 300 in FIG. 2) will be described. After the deadline for application for event participation has passed (“YES” in STEP 115 in FIG. 4), the output means 26 outputs information regarding whether or not each participant can participate in the event, based on the status of conclusion of the non-disclosure agreement between the participants of the event concluded by the agreement conclusion means 24 (STEP 311 in FIG. 4). Then, the transmission means 28 transmits the information outputted by the output means 26 regarding whether or not each participant can participate in the event, to the event participation restriction device 56 or the online conference management system 58 (STEP 312 in FIG. 4). Accordingly, each participant restricted from participating in the event can be prevented from participating in the event. Instead of or in addition to the transmission means 28 transmitting, to the event participation restriction device 56 or the online conference management system 58, the information outputted by the output means 26 regarding whether or not each participant can participate in the event, the information outputted by the output means 26 regarding whether or not each participant can participate in the event may be printed on paper by the printing unit 36 (STEP 312 in FIG. 4). In this case, the paper on which information regarding whether or not each participant can participate in the event is printed is brought to the real event venue, whereby the event receptionist can permit or restrict participation of each participant in the event while viewing the information printed on the paper.

Next, the third mode of the flow of the information processing by the computer 10 of the present embodiment will be described. In the third mode, after the registration process is performed, the non-disclosure agreement conclusion process and the event participation management process are performed in an integrated manner on the day of the event. The details of the flow of information processing according to such a third mode will be described with reference to the flowchart in FIG. 5.

First, the details of the registration process (STEP 100 in FIG. 2) will be described. When a participant who wishes to participate in an event inputs registration information by means of the first user terminal 50 or the second user terminal 52, the inputted registration information is transmitted from the first user terminal 50 or the second user terminal 52 to the computer 10 via the communication network 40 such as an Internet line. When the acceptance means 22 accepts registration information regarding a participant of an event (“YES” in STEP 121 in FIG. 5), the control unit 20 stores the registration information regarding the participant in the event, in the storage unit 34 (STEP 122 in FIG. 5). Until an deadline for application for event participation has passed (“NO” in STEP 123 in FIG. 5), each participant who wishes to participate in the event can register for participation in the event by means of the first user terminal 50 or the second user terminal 52.

After the deadline for application for event participation has passed (“YES” in STEP 123 in FIG. 5), if the acceptance means 22 accepts, on the day of the event from the event participation confirmation device 54 such as a camera, an IC tag reader, a barcode reader, or a personal computer installed, for example, at the entrance or the like of a predetermined real event venue or an event venue in a predetermined virtual space, participation information regarding participation of a participant in the event (“YES” in STEP 221 in FIG. 5), the transmission means 28 transmits confirmation information as to whether or not to conclude a non-disclosure agreement with a new participant, to the terminal of each of other participants whose participation information has already been accepted (STEP 222 in FIG. 5). Specifically, when the participant holding the first user terminal 50 has already entered the event venue and the participant holding the second user terminal 52 is about to enter the event venue, if participation information regarding participation in the event of the participant holding the second user terminal 52 is accepted, the transmission means 28 transmits confirmation information as to whether or not to conclude a non-disclosure agreement with the holder of the second user terminal 52 who is a new participant, to the first user terminal 50 which has already entered the event venue and whose participation information has been accepted. Here, confirmation information as to whether or not to conclude a non-disclosure agreement with another participant who has already entered the event venue and whose participation information has been accepted, may be transmitted to the second user terminal 52.

Then, the participant who holds the first user terminal 50 and who has already entered the event venue inputs information as to whether or not to conclude a non-disclosure agreement with the participant holding the second user terminal 52, by means of the first user terminal 50. Then, if the participant holding the first user terminal 50 inputs information indicating that a non-disclosure agreement with the participant holding the second user terminal 52 is to be concluded by means of the first user terminal 50, agreement information indicating that the participant holding the first user terminal 50 is also willing to conclude a non-disclosure agreement with the participant holding the second user terminal 52 is transmitted from the first user terminal 50 to the computer 10.

Then, if the acceptance means 22 accepts, from the first user terminal 50, the agreement information indicating that a non-disclosure agreement with the participant holding the second user terminal 52 is to be concluded, the agreement conclusion means 24 concludes a non-disclosure agreement between the participant holding the first user terminal 50 and the participant holding the second user terminal 52 (STEP 223 in FIG. 5). Then, based on the status of conclusion of the non-disclosure agreement between the participants of the event concluded by the agreement conclusion means 24, the output means 26 outputs information regarding whether or not each participant can participate in the event. Such processes are performed until an event start time (“YES” in STEP 224 in FIG. 5). When the event start time has arrived, the transmission means 28 transmits a display instruction signal for displaying a message urging leaving the event venue, to the terminal of each participant who has not concluded a non-disclosure agreement with any other participant, based on the information outputted by the output means 26 regarding whether or not each participant can participate in the event. Based on the information outputted by the output means 26 regarding whether or not each participant can participate in the event, an announcement urging each participant who has not concluded a non-disclosure agreement with any other participant to leave the event venue may be made in the event venue before a session starts, or an event staff member may call out to each participant who has not concluded a non-disclosure agreement with any other participant, to urge this participant to leave the event venue. Thus, the participants who have not concluded a non-disclosure agreement with any other participant (specifically, e.g., a presenter) can be prevented from participating in the event.

In the case where multiple rooms are set up in the event venue and each session is held in each room, the event participation confirmation device 54 may be installed at the entrance of the event venue, and the event participation restriction device 56 may be installed at the entrance of each room. In this case, when the processing according to the third mode described above is performed by the computer 10, if the participants are confirmed by the event participation confirmation device 54 installed at the entrance of the event venue, the participation information regarding participation of each participant in the event is transmitted from the event participation confirmation device 54 to the computer 10, whereby the acceptance means 22 accepts the participation information regarding participation of each participant in the event. In addition, since the event participation restriction device 56 is installed at the entrance of each room where a session is held, the event participation restriction device 56 prevents each participant from entering any room where a session is held, if the participant does not conclude a non-disclosure agreement with any other participant in the event venue. Specifically, the information outputted by the output means 26 regarding whether or not each participant can participate in the event is transmitted from the computer 10 to the event participation restriction device 56. Then, in the case where the event participation restriction device 56 is, for example, a gate facility, the gate is closed for each participant restricted from participating in the event, based on the information transmitted from the computer 10 regarding whether or not each participant can participate in the event, whereby this participant cannot enter the room where the session is held.

A list of participants who have applied for participation in the event and whose registration information is stored in the storage unit 34 may be transmitted to each terminal 50 or 52 of the participants in advance. In this case, each participant can know in advance information on the other participants (e.g., names of participants, etc.) before entering the event venue. Each participant may be able to pre-register other participants who do not conclude a non-disclosure agreement, by means of the terminal 50 or 52 held by the participant. In this case, the output means 26 outputs information indicating that participation of auditors who have not concluded a non-disclosure agreement with a presenter is to be restricted, for example. Subsequently, on the day of the event, when participants enter the event venue and their participation in the event is confirmed by the event participation confirmation device 54, the agreement conclusion means 24 concludes a non-disclosure agreement between the participants whose participation has been confirmed by the event participation confirmation device 54. Specifically, for example, by a participant entering the event venue and participation of this participant in the event being confirmed by the event participation confirmation device 54, this participant consents to the conclusion of a non-disclosure agreement with each participant whose participation in the event has already been confirmed. This participant also applies for the conclusion of a non-disclosure agreement with each participant who is planning to participate in the event and whose participation in the event has not yet been confirmed.

Although the operation in which the registration process is performed by the computer 10 has been described in the above first mode to third mode, the present embodiment is not limited to such an operation. As another operation, by having a participant send by mail or fax an application form having registration information thereon to the office that holds the event, a staff member of the office may perform a registration process of accepting the registration information regarding the participant of the event. In this case as well, the staff member of the office inputs information regarding the participant to the event into the control unit 20 by means of the operation unit 32 in the computer 10, whereby the acceptance means 22 of the computer 10 accepts the information regarding the participant to the event.

Although the operation in which the non-disclosure agreement process is performed by the agreement conclusion means 24 of the computer 10 has been described in the above first mode to third mode, the present embodiment is not limited to such an operation. As another operation, by inquiring of the participants of the event as to whether or not to conclude a non-disclosure agreement with another participant, a staff member of the office that holds the event may confirm whether the participants conclude a non-disclosure agreement with each other. In this case, the staff member of the office inputs information regarding whether or not a non-disclosure agreement is concluded between the participants to the event, for each participant, into the control unit 20 by means of the operation unit 32 in the computer 10, whereby the agreement conclusion means 24 of the computer 10 concludes a non-disclosure agreement between the participants whose registration information has been accepted by the acceptance means 22.

In the above first mode to third mode, the content of the non-disclosure agreement to be concluded by the agreement conclusion means 24 may be determined based on an option selected from a plurality of agreement content options accepted from the terminal of the presenter by the acceptance means 22. Specifically, as described above, the agreement content options include the level of the non-disclosure agreement, the period of validity of the non-disclosure agreement, etc. Also, the agreement content options may include an item of whether or not to add a provision that a patent application shall not be filed for any matter regarding the content of the presentation in the session until a predetermined period of time has elapsed from the date of the event, or a provision that the presenter shall be notified if a patent application is to be filed for a matter regarding the content of the presentation at the session until a predetermined period of time has elapsed from the date of the event.

In the above first mode to third mode, the registration information regarding the participants of the event may include information that is at least either a legal entity or an individual. When a participant who wishes to participate in the event inputs registration information by means of the first user terminal 50 or the second user terminal 52, if a plurality of legal entities are registered when inputting information as to which between a legal entity and an individual the participant is, the participant inputs information as to which legal entity is to be held responsible when a secret is leaked. Accordingly, when a participant is associated with a plurality of legal entities in the registration information accepted by the acceptance means 22, the acceptance means 22 accepts information as to which legal entity is to be held responsible when a secret is leaked. In this case, even when a participant is associated with a plurality of legal entities, it is possible to clarify which legal entity is to be held responsible when this participant leaks a secret.

In the program, the information processing device (specifically, the computer 10), the information processing system 1, and the information processing method of the present embodiment configured as described above, the program causes the computer 10 to function as the acceptance means 22, the agreement conclusion means 24, and the output means 26, the acceptance means 22 accepts registration information regarding participants of an event, the agreement conclusion means 24 concludes a non-disclosure agreement between the participants whose registration information has been accepted by the acceptance means 22, and the output means 26 outputs information regarding whether or not each participant can participate in the event, based on the status of conclusion of the non-disclosure agreement between the participants of the event concluded by the agreement conclusion means 24. In this case, by outputting the information regarding whether or not each participant can participate in the event based on the status of conclusion of the non-disclosure agreement between the participants of the event, the participants can safely present and talk about things that the participants do not want to leak outside of the event.

In the program, the information processing device (specifically, the computer 10), the information processing system 1, and the information processing method of the present embodiment, as described above, the information regarding whether or not each participant can participate in the event includes at least any of whether or not each participant can enter a predetermined real event venue, whether or not each participant can enter an event venue in a predetermined virtual space, and whether or not each participant can participate in a predetermined online conference. In this case, at the event held at the predetermined real event venue, the event held at the event venue in the predetermined virtual space, or the predetermined online conference, the participants can safely present and talk about things that the participants do not want to leak outside.

In the program, the information processing device (specifically, the computer 10), the information processing system 1, and the information processing method of the present embodiment, as described above, the program further causes the computer 10 to function as the transmission means 28, and when the agreement conclusion means 24 concludes a non-disclosure agreement between the participants of the event, the transmission means 28 transmits confirmation information for confirming whether or not to conclude a non-disclosure agreement with another participant, to the terminal of each participant whose registration information has been accepted by the acceptance means 22, and the agreement conclusion means 24 concludes a non-disclosure agreement between the participants of the event based on the agreement information, accepted by the acceptance means 22 from the terminal of each participant, as to whether or not to conclude a non-disclosure agreement with another participant. In this case, the agreement conclusion means 24 can conclude a non-disclosure agreement between the participants of the event based on the agreement information transmitted from the terminal of each participant.

In this case, the confirmation information is information for confirming for each of other participants whether or not to conclude a non-disclosure agreement with another participant, and the agreement information is information of each of other participants as to whether or not to conclude a non-disclosure agreement. Accordingly, the agreement conclusion means 24 can conclude a non-disclosure agreement with each of other participants for each participant, rather than collectively concluding non-disclosure agreements for a plurality of participants.

In the program, the information processing device (specifically, the computer 10), the information processing system 1, and the information processing method of the present embodiment, as described above, the computer 10 is further caused to function as the transmission means 28, and when the agreement conclusion means 24 concludes a non-disclosure agreement between the participants of the event, if the acceptance means 22 accepts registration information regarding the participants of the event, the transmission means 28 transmits confirmation information for confirming whether or not to conclude a non-disclosure agreement with each of other participants who have already registered for participation in the event, to the terminal of each participant whose registration information has been accepted, and the agreement conclusion means 24 concludes a non-disclosure agreement between the participants of the event based on the agreement information, accepted by the acceptance means 22 from this terminal, as to whether or not to conclude a non-disclosure agreement with another participant. In this case, the agreement conclusion means 24 can conclude a non-disclosure agreement with each of other participants who have already registered for participation each time a participant registers for participation.

In this case, the confirmation information is information for confirming for each of other participants whether or not to conclude a non-disclosure agreement with each of other participants who have already registered for participation in the event, and the agreement information is information of each of other participants as to whether or not to conclude a non-disclosure agreement. Accordingly, the agreement conclusion means 24 can conclude a non-disclosure agreement with each of other participants for each participant, rather than collectively concluding non-disclosure agreements for a plurality of participants.

In the program, the information processing device (specifically, the computer 10), the information processing system 1, and the information processing method of the present embodiment, as described above, the program further causes the computer 10 to function as the transmission means 28, and the transmission means 28 transmits the information outputted by the output means 26 regarding whether or not each participant can participate in the event, to the event participation restriction device 56 or the online conference management system 58 which selectively restricts each participant from participating in the event. In this case, based on the information outputted by the output means 26 regarding whether or not each participant can participate in the event, the event participation restriction device 56 or the online conference management system 58 can prevent each participant restricted from participating in the event from participating in the event.

In the program, the information processing device (specifically, the computer 10), the information processing system 1, and the information processing method of the present embodiment, as described above, the acceptance means 22 accepts participation information regarding participation of the participants in the event from the event participation confirmation device 54, and the agreement conclusion means 24 concludes a non-disclosure agreement between the participants of the event when the acceptance means 22 accepts from the event participation confirmation device 54 the participation information regarding participation in the event of a participant whose registration information has been accepted by the acceptance means 22. In this case, the non-disclosure agreement process and the event participation management process can be performed together.

In the program, the information processing device (specifically, the computer 10), the information processing system 1, and the information processing method of the present embodiment, as described above, the registration information regarding the participants of the event includes information that is at least either a presenter or an auditor, and for a participant whose registration information is an auditor, the output means 26 outputs information that permits the participant to participate in the event even if a non-disclosure agreement has not been concluded with any other auditor by the agreement conclusion means 24 but restricts the participant from participating in the event if a non-disclosure agreement has not been concluded with the presenter. In this case, the presenter can participate in the event even if the presenter has not concluded a non-disclosure agreement with any other participant, but each auditor is restricted from participating in the event if a non-disclosure agreement has not been concluded with the presenter, and each auditor can be allowed to participate in the event even if a non-disclosure agreement has not been concluded between the auditors.

The registration information regarding the participants of the event further includes information that is a conversation person, and for a participant whose registration information is a conversation person, the output means 26 outputs information that restricts the participant from participating in the event if a non-disclosure agreement has not been concluded with any other participant by the agreement conclusion means 24. In this case, the conversation person can be restricted from participating in the event if a non-disclosure agreement has not been concluded with any other participant.

In the program, the information processing device (specifically, the computer 10), the information processing system 1, and the information processing method of the present embodiment, as described above, the status of conclusion of the non-disclosure agreement includes whether or not the non-disclosure agreement has been concluded and information on the content of the non-disclosure agreement, and the content of the non-disclosure agreement to be concluded by the agreement conclusion means 24 is determined based on an option selected from a plurality of agreement content options accepted from the terminal of a participant by the acceptance means 22. In this case, the content of the non-disclosure agreement to be concluded by the agreement conclusion means 24 can have variations, and thus a non-disclosure agreement can be concluded between the participants with the agreement content determined based on the selected option.

In the program, the information processing device (specifically, the computer 10), the information processing system 1, and the information processing method of the present embodiment, as described above, the registration information regarding the participants of the event includes information that is at least either a legal entity or an individual, and when a participant is associated with a plurality of legal entities in the registration information, the acceptance means 22 accepts information as to which legal entity is to be held responsible when a secret is leaked. In this case, even when a participant is associated with a plurality of legal entities, it is possible to clarify which legal entity is to be held responsible when this participant leaks a secret.

The program, the information processing device, the information processing system, and the information processing method according to the present invention are not limited to the modes described above, and various modifications can be made.

For example, the program to be executed by the control unit of the computer is not limited to a program stored in the storage unit of the computer. As the program to be executed by the control unit, a program transmitted from an external device to the control unit via the communication unit, a program stored in a storage medium such as a USB memory attached to the computer, a program stored in a computer separate from the computer, a server (e.g., a cloud server), or the like, etc., may be used.

For example, the first mode to third mode have been described as a method by which the agreement conclusion means concludes a non-disclosure agreement between the participants of the event, but the present invention is not limited to such modes. Methods other than those described above may be used as the method by which the agreement conclusion means concludes a non-disclosure agreement between the participants of the event.

In the above modes, the example in which the agreement conclusion means 24 of the computer 10 concludes a non-disclosure agreement between the participants whose registration information has been accepted by the acceptance means 22, has been described, but the present invention is not limited to such modes. As another mode, a computer for concluding a non-disclosure agreement between the participants to the event may be provided separately from the computer according to the present invention. In this case, from the computer for concluding a non-disclosure agreement between the participants to the event, information regarding the status of conclusion of a non-disclosure agreement between the participants is transmitted to the computer according to the present invention. Then, based on the accepted status of conclusion of a non-disclosure agreement between the participants of the event, the computer according to the present invention outputs information regarding whether or not each participant can participate in the event. That is, a computer in which the agreement conclusion means 24 is not provided as compared to the computer 10 shown in FIG. 1, may be used as the computer according to the present invention. Even with the computer according to such a modification and a program to be executed by this computer, acceptance means accepts information regarding the status of conclusion of a non-disclosure agreement between the participants of the event, and output means outputs information regarding whether or not each participant can participate in the event based on the accepted status of conclusion of a non-disclosure agreement between the participants of the event, whereby the participants can safely present and talk about things that the participants do not want to leak outside of the event.

For example, if there is a participant who is late for the event (latecomer), when the participation of the latecomer in the event is confirmed by the event participation confirmation device 54, the output means 26 may output information regarding an indication that a non-disclosure agreement with the latecomer is to be concluded, to the second user terminal 52 of the participant who has already participated in the event. Accordingly, regardless of how many latecomers there are, each participant who has already participated in the event can quickly and easily conclude a non-disclosure agreement with each latecomer without interrupting the event, by merely pressing the indication that a non-disclosure agreement is to be concluded which is displayed on the second user terminal 52. Therefore, the complexity of concluding a non-disclosure agreement again with all participants in the event can be avoided.

1. An information processing device comprising a control unit and a storage unit, wherein
by the control unit executing a program stored in the storage unit, the information processing device
accepts registration information regarding participants of an event,
concludes a non-disclosure agreement between the participants whose registration information has been accepted, and
outputs information regarding whether or not each participant can participate in the event based on a status of conclusion of the non-disclosure agreement concluded between the participants of the event.

2. The information processing device according to claim 1, wherein the information regarding whether or not each participant can participate in the event includes at least any of whether or not each participant can enter a predetermined real event venue, whether or not each participant can enter an event venue in a predetermined virtual space, and whether or not each participant can participate in a predetermined online conference.

3. The information processing device according to claim 1, wherein, in concluding a non-disclosure agreement between the participants of the event, the information processing device transmits confirmation information for confirming whether or not to conclude a non-disclosure agreement with another participant to a terminal of each participant whose registration information has been accepted, and concludes a non-disclosure agreement between the participants of the event based on agreement information, accepted from the terminal of each participant, as to whether or not to conclude a non-disclosure agreement with another participant.

4. The information processing device according to claim 3, wherein the confirmation information is information for confirming for each of other participants whether or not to conclude a non-disclosure agreement with another participant, and the agreement information is information of each of other participants as to whether or not to conclude a non-disclosure agreement.

5. The information processing device according to claim 1, wherein, when concluding a non-disclosure agreement between the participants of the event, if the information processing device accepts the registration information regarding the participants of the event, the information processing device transmits confirmation information for confirming whether or not to conclude a non-disclosure agreement with another participant who has already registered for participation in the event, to a terminal of a participant whose registration information has been accepted, and concludes a non-disclosure agreement between the participants of the event based on agreement information, accepted from the terminal, as to whether or not to conclude a non-disclosure agreement with another participant.

6. The information processing device according to claim 5, wherein the confirmation information is information for confirming for each of other participants whether or not to conclude a non-disclosure agreement with another participant who has already registered for participation in the event, and the agreement information is information of each of other participants as to whether or not to conclude a non-disclosure agreement.

7. The information processing device according to claim 1, wherein the information processing device transmits the outputted information regarding whether or not each participant can participate in the event, to an event participation restriction device or an online conference management system configured to selectively restrict each participant from participating in the event.

8. The information processing device according to claim 1, wherein
the information processing device accepts participation information regarding participation of a participant in the event, from an event participation confirmation device, and
when the information processing device accepts, from the event participation confirmation device, participation information regarding participation in the event of a participant whose registration information has been accepted, the information processing device concludes a non-disclosure agreement between the participants of the event.

9. The information processing device according to claim 1, wherein
the registration information regarding the participants of the event includes information that is at least either a presenter or an auditor, and
for a participant whose registration information is an auditor, the information processing device outputs information that permits the participant to participate in the event even if a non-disclosure agreement has not been concluded with any other auditor but restricts the participant from participating in the event if a non-disclosure agreement has not been conducted with a presenter.

10. The information processing device according to claim 9, wherein
the registration information regarding the participants of the event further includes information that is a conversation person, and
for a participant whose registration information is a conversation person, the information processing device outputs information that restricts the participant from participating in the event if a non-disclosure agreement has not been concluded with any other participant.

11. The information processing device according to claim 9, wherein
the status of conclusion of the non-disclosure agreement includes whether or not the non-disclosure agreement has been concluded and information on a content of the non-disclosure agreement, and
the content of the non-disclosure agreement to be concluded is determined based on an option selected from a plurality of agreement content options accepted from a terminal of the presenter.

12. The information processing device according to claim 1, wherein
the registration information regarding the participants of the event includes information that is at least either a legal entity or an individual, and
when a participant is associated with a plurality of legal entities in the registration information, the information processing device accepts information as to which legal entity is to be held responsible when a secret is leaked.

13. The information processing device according to claim 1, wherein, when there are participants who participate in the event at different times, the information processing device outputs information regarding an indication for conclusion of the non-disclosure agreement between the participant who participates in the event later and the participant who has already participated in the event.

14. (canceled)

15. A system comprising an information processing device and an event participation restriction device, wherein
the information processing device includes a control unit and a storage unit,
by the control unit executing a program stored in the storage unit, the information processing device
accepts registration information regarding participants of an event,
concludes a non-disclosure agreement between the participants whose registration information has been accepted,
outputs information regarding whether or not each participant can participate in the event based on a status of conclusion of the non-disclosure agreement concluded between the participants of the event, and
transmits the outputted information regarding whether or not each participant can participate in the event, to the event participation restriction device, and
the event participation restriction device selectively restricts each participant from participating in the event based on the information, transmitted from the information processing device, regarding whether or not each participant can participate in the event.

16. An information processing method performed by a computer, the information processing method comprising:
causing the computer to accept registration information regarding participants of an event;
causing the computer to conclude a non-disclosure agreement between the participants whose registration information has been accepted; and
causing the computer to output information regarding whether or not each participant can participate in the event based on a status of conclusion of the non-disclosure agreement concluded between the participants of the event.
